(19) United States
(12) Patent Application Publication
(10) Pub. No.: US 2007/0287804 A1
(43) Pub. Date: Dec. 13, 2007

(54) Thermoplastic elastomer composition and laminate

(75) Inventor: Takeshi Tominaga, Sodegaura (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 11/806,868

(22) Filed: Jun. 5, 2007

(30) Foreign Application Priority Data
Jun. 8, 2006 (JP) 2006-159484

(51) Int. Cl. C08L 23/04

(52) U.S. Cl. 525/240

(57) ABSTRACT

The present invention has an object to provide a thermoplastic elastomer composition with a small adhesiveness to calender roll and having a stable drawdown property in a broad temperature range in vacuum forming. The present invention relates to a thermoplastic elastomer composition comprising the following component (A) in an amount of 5 to 94% by weight, the following component (B) in an amount of 1 to 90% by weight and the following component (C) in an amount of 5 to 70% by weight, with the proviso that an amount in total of the components (A), (B) and (C) is set to 100% by weight:
(A) an ethylene-α-olefin copolymer rubber;
(B) a polypropylene resin which satisfies the following equation (1) in a melt tension (MT) at 190° C. and a melt flow rate (MFR) at 230° C.

log MT>−0.9 log MFR+0.8; (1)

and
(C) a polyethylene resin comprising: an ethylene monomer alone: or a monomer unit derived from ethylene and a monomer unit derived from α-olefin with 3 to 20 carbon atoms and having a density of 890 to 970 kg/m³.

### FIELD OF THE INVENTION

The present invention relates to a thermoplastic elastomer composition and a laminate. More particularly, the present invention relates to the thermoplastic elastomer composition and the laminate for vacuum forming which are superior in roll processing as well as exhibiting excellent vacuum forming property typified by a drawdown property in the vacuum forming.

### BACKGROUND OF THE INVENTION

Since a thermoplastic elastomer has specific properties that it is able to be processed by conventional forming machine for a thermoplastic resin and is easier to recycle compared to conventional vulcanized rubbers, various examinations have been performed for the thermoplastic elastomer in use for automobile parts, parts of household appliances, housing, groceries, etc. These products can be produced by combining of the primary processing of sheet molding by using calender molding or extrusion molding of raw material resin with the secondary processing of shaping to the shape of final product by molding method typified by the vacuum forming.

Examples of materials preferred for such manufacturing method which have been known are thermoplastic elastomer compositions, to which the cross-linked structure is imparted by dynamic processing of the copolymer blend of polyolefin resin and ethylene-α-olefin copolymer rubber. However, in the production thereof, the degree of cross-linking of ethylene-α-olefin copolymer rubber used in the thermoplastic elastomer composition should be properly controlled, and the operation with complicated working and specific equipment has to be required.

Meanwhile, a blended material consisting of a polyolefin resin without imparting a cross-linking process and ethylene-α-olefin copolymer rubber can be easily produced by conventional extruder, however it has problem that when vacuum forming is performed, generation of ruck and break is observed due to too much drawdown of the sheet.

Consequently, a development of thermoplastic elastomer having combination of easier material production and excellent vacuum forming properties typified by drawdown property is demanded.

JP-A-8-73674 discloses polypropylene resin composition with excellent drawdown property without using partially cross-linked α-olefin copolymer by using polypropylene resin having specific branching.

### BRIEF SUMMARY OF THE INVENTION

However, the polypropylene resin composition disclosed in JP-A-8-73674 has sometimes inferior primary processability for sheet molding by using the calendering molding machine. Specifically, the sheet molding performed by conventionally used calendering molding machine leads to worse productivity caused by twisting or adhering the polypropylene resin composition around the roll surface.

The present inventors have extensively studied a way to develop the thermoplastic elastomer composition having the superior primary processability typified by the calender processing as well as having stable drawdown property within broad temperature range in the vacuum forming, and as a result have found that the thermoplastic elastomer composition compounded with specific components exhibited extremely excellent property, and completed the present invention.

The first aspect of the present invention relates to a thermoplastic elastomer composition comprising the following component (A) in an amount of 5 to 94% by weight, the following component (B) in an amount of 1 to 90% by weight and the following component (C) in an amount of 5 to 70% by weight, with the proviso that an amount in total of the components (A), (B) and (C) is set to 100% by weight:

(A) an ethylene-α-olefin copolymer rubber;

(B) a polypropylene resin which satisfies the following equation (1) in a melt tension (MT) at 190° C. and a melt flow rate (MFR) at 230° C.

log MT>−0.9 log MFR+0.8 (1);

and

(C) a polyethylene resin comprising: an ethylene monomer alone; or a monomer unit derived from ethylene and a monomer unit derived from α-olefin with 3 to 20 carbon atoms and having a density of 890 to 970 kg/m³.

Another aspect of the present invention relates to a laminate comprising: a layer comprising an urethane-based foam or an olefin-based foam; and the above thermoplastic elastomer composition. Further, the present invention relates to a molding method comprising the step of: vacuum forming the above thermoplastic elastomer composition or the above laminate at a temperature of a melting point or above of the component (B) to obtain a molded product, and the present invention relates to a vacuum formed product obtained thereby.

The melting point used herein indicates the melting peak temperature on a curve of differential scanning calorimetry measured according to JIS K-7121 (1987).

### DETAILED DESCRIPTION OF THE INVENTION

Ethylene-α-olefin based copolymer rubber (A) of the present invention is preferably a copolymer rubber containing ethylene monomer unit and α-olefin monomer unit, and the olefin monomer unit as a main component. The component (A) has a different definition from polypropylene resin (B) and polyethylene resin (C) on the point that the component (A) is a polymer without showing melting peak ranging from 90 to 170° C. (inclusive) on the curve of differential scanning calorimetry measured according to JIS K-7121 (1987). Examples of α-olefin which can be mentioned are, for example, propylene, 1-butene, 1-pentene, 1-hexene, 4-methyl-1-pentene, 1-octene, 1-decene, etc. and among them, propylene is preferred. Further, the monomer unit other than olefin, for example, nonconjugated diene unit such as 1,4-hexadiene, dicyclopentadiene, 5-ethylidene-2-norbornene, etc. may be contained. For example, ethylene-propylene copolymer rubber (EPR) and ethylene-propylene-nonconjugated diene copolymer rubber (EPDM) can be mentioned.

Mooney viscosity of the ethylene-α-olefin copolymer rubber (A) at 100° C. (MLₗ₊₄ 100° C.) is preferably 10 or above, more preferably 30 or more from the standpoint of increasing mechanical strength of the obtained thermoplastic elastomer composition, and the Mooney viscosity is preferably 350 or less, more preferably 300 or less from the standpoint of improved appearance of the molded product.

Ethylene content of ethylene-α-olefin copolymer rubber (A) is preferably 10 to 80% by weight, more preferably 30 to 78% by weight, further preferably 50 to 75% by weight. When ethylene content is less than 10% by weight, mechanical property and stabilities against heat, oxygen and light may be reduced, and when the content is more than 80% by weight, flexibility may be reduced.

Ethylene-α-olefin copolymer rubber (A) is preferably produced by known polymerization process using known catalyst for polymerization of olefin. For example, slurry polymerization, solution polymerization, mass (bulk) polymerization, gas phase polymerization, etc. using Ziegler-Natta catalyst or complex catalyst such as metallocene complex and non-metallocene complex can be mentioned.

Mineral oil softening agent may be contained in the component (A). Examples of conventional mineral oil softening agent which can be used are aromatic, naphthenic and paraffinic mineral oil. Among mineral oils, paraffinic mineral oil is preferable from the standpoint of appearance of molded product and high-color tone. Mineral oil softening agent may be blended as extender oil in ethylene-α-olefin copolymer rubber (A), and in this case, oil extended rubber is used as the ethylene-α-olefin copolymer rubber (A) containing mineral oil softening agent. Use of the oil extended rubber is preferable in order to increase in upper limit of the blending ratio for external discharge of the mineral oil softening agent.

The polypropylene resin (B) of the present invention is the polymer with content of monomer unit derived from propylene being preferably 51% by weight or more, more preferably 80% by weight or more, with the proviso that content of total monomer unit in the polypropylene resin (B) is set as 100% by weight, and the polymer has the melting peak temperature in the range between 90 and 170° C. (inclusive) on a curve of differential scanning calorimetry measured according to JIS K-7121 (1987). The polypropylene resin (B) may contain the monomer unit derived from olefin other than propylene, and examples of olefin other than the propylene which can be mentioned are ethylene, 1-butene, 1-pentene, 1-hexene, 4-methyl-1-pentene, 1-octene, 1-decene, etc. Further, preferred polypropylene resin is the resin having heat quantity of melting at the melting peak between 50 and 130 J/g (inclusive).

Examples of the polypropylene resin (B) which can be mentioned are propylene homopolymer, ethylene-propylene copolymer, propylene-1-butene copolymer, propylene-1-hexene copolymer, propylene-1-octene copolymer, propylene-ethylene-1-butene copolymer, ethylene-propylene-1-hexene copolymer, etc. These are used in combination with one or more thereof.

The polypropylene resin (B) satisfies the following equation (1) in the melt tension (MT) at 190° C. and the melt flow rate (MFR) at 230° C., preferably satisfies the following equation (1a), more preferably satisfies the following equation (1b). When MT and MFR of the polypropylene resin (B) satisfy such the equation, superior drawdown property can be observed. In the equation hereinbelow, MT shows the tensile force (unit=cN) measured by using melt tension tester Type MT-501D3, Toyo Seiki Co., Ltd., when strand is extruded using the sample 5 g from the orifice with a length 8 mm and a diameter 2 mm, at residual temperature of 190° C., for residual heat time of 5 minutes, and at extrusion rate 5.7 mm/min., and the strand is rolled up at rolling rate of 15.7 m/min. using a roller with a diameter 50 mm.

Further, MFR is a value measured by the method A under the condition at temperature of 230° C., loading of 21.18 N according to the method defined in JIS K7210 (1995).

log MT>−0.9 log MFR+0.8 (1)

log MT≧−0.9 log MFR+1.4 (1a)

log MT≧−0.9 log MFR+2.0 (1b)

MFR of polypropylene resin (B) used in the present invention at 230° C. is not limited, and is preferably 0.1 to 30 g/10 min., more preferably 0.3 to 20 g/10 min. When MRF is too low, the processability of thermoplastic elastomer may be deteriorated. Further, when MFR is too high, it is not preferable due to deterioration of drawdown property.

Examples of polypropylene resin (B) used in the present invention which can be mentioned are, for example, a nonlinear propylene polymer resin with extensional viscosity of distortion curability and a propylene polymer with broad molecular weight distribution produced by multistep polymerization. The former nonlinear propylene polymer resin with extensional viscosity of distortion curability is distributed in the market by Bazel Inc. U.S. and others.

Molecular weight distribution of the polypropylene resin (B) used in the present invention is preferably 15 or less, more preferably 5 to 12 (inclusive), further more preferably 6 or more and below 10. Material having property within this range is preferable due to exhibiting superior appearance of the molded product. The molecular weight distribution (Mw/Mn) is a value (Mw/Mn) dividing Mw by Mn after obtaining weight-average molecular weight (Mw) and number average molecular weight (Mn) converted to polystyrene by the gel-permeation chromatography.

The polypropylene resin (B) used in the present invention is a polypropylene resin (B1) comprising a propylene-based polymer containing a crystalline propylene-based polymer component (b1) and a crystalline propylene-based polymer component (b2) wherein, in the first step, the component (b1) having a limiting viscosity of 5 dl/g or more is produced by polymerizing a monomer comprising propylene as a main component and, continuously afterward in the second step, the component (b2) having a limiting viscosity of below 3 dl/g is continuously produced by polymerizing a monomer comprising propylene as a main component, and a content of the component (b1) in the propylene-based polymer is 0.05% by weight or more and below 25% by weight, and a limiting viscosity of the total propylene-based polymer is below 3 dl/g and a molecular weight distribution Mw/Mn is below 10.

The polypropylene resin (B1) of the present invention consists of preferably the component (b1) and the component (b2). Isotacetic propylene polymer is preferably used as the component (b1) herein. Among them, a homopolymer of propylene, or a copolymer of propylene and α-olefin having carbon number 4 to 12 and a copolymer of propylene and ethylene maintaining the property to the extent not to lose crystallinity are particularly preferred. Examples of α-olefin which can be mentioned are 1-butene, 4-methylpentene-1,1-octene, 1-hexene, etc. Copolymerization is performed for the purpose of controlling flexibility, transparency, etc., and content of monomer other than propylene is preferably 10% by weight or less for ethylene and 30% by weight or less for the α-olefin. Among them, the crystalline propylene copolymer component selected from the group consisting of a propylene homopolymer, a random copolymer with propylene and 10% by weight or less of ethylene, a random copolymer with propylene and 30% by weight or less of α-olefin having carbon number 4 to 12, or a ternary random copolymer with propylene, 10% by weight or less of ethylene and 30% by weight or less of α-olefin having carbon number 4 to 12 is more preferably used, further an example of preferable α-olefin is 1-butene. Especially preferable component (b1) on the point of flexibility and transparency is a copolymer containing 1% by weight or more and 10% by weight or less of ethylene.

The limiting viscosity of the component (b1) is 5 dl/g or more, and preferably 6 dl/g or more, more preferably 7 dl/g or more. When it is less than 5 dl/g, polypropylene resin is less in melting tensile force and an object of the present invention may not be achieved.

Ratio occupied by the component (b1) in the total propylene polymer is preferably 0.05% by weight or more and less than 25% by weight. It is more preferably 0.3% by weight or more and less than 20% by weight. When it is less than 0.05% by weight, it may be less in melt strength. When amount of the component (b1) is 25% by weight or more, not only fluidity may be reduced but also the elongation characteristic may be deteriorated and an object of the present invention may not be achieved.

Amount of the component (b1) which satisfies the following equation (2) is especially preferable from the standpoint of the melt strength. When amount of the component (b1) satisfies the equation (2), superior improvement effect of the melting tensile force is observed. EXP(X) herein represents eX, and e is base of natural logarithm.

Content of component (b1) (% by weight)≧400×EXP(−0.6×limiting viscosity (dl/g) of component (b1)) (2)

Component (b2) of the present invention is preferably the propylene polymer obtained by continuous production afterward the production of the component (b1). Specifically, a monomer consisting primarily of propylene can be polymerized in the presence of a stereospecific olefin polymerization catalyst typified by, for example, Ziegler-Natta catalyst to produce the component (b1), and subsequently a monomer consisting primarily of propylene can be polymerized in the presence of the catalyst and the polymer to produce the component (b2), blending simply the crystalline propylene polymer with the limiting viscosity of 5 dl/g or more and the propylene polymer with the limiting viscosity of below 3 dl/g may exhibit insufficient on the point of improvement effect of the melting tensile force.

Specific examples of the process for production of the polymer include batch-wise polymerization wherein after the component (b1) is polymerized, subsequently the component (b2) is polymerized in the same polymerization tank, or the polymerization wherein the polymerization tanks consisting of at least two tanks are arranged in line, and after the polymerization of the component (b1) is performed, the product is transferred into the next polymerization tank, subsequently the component (b2) is polymerized in such the polymerization tank.

The limiting viscosity of the component (b2) is less than 3 dl/g, preferably below 2 dl/g. When it is 3 dl/g or more, the limiting viscosity of the total polymer is too high, resulting in inferior fluidity, which may cause problem in the processing. Even if the viscosity of the total system is adjusted by adding other component, it may be problem on the point of miscibility or the like. In addition, the limiting viscosity [η]_{b2} of the component (b2) is a value calculated by the following equation (3).

[η]b2=([η]T×100−[η]b1×Wb1)/Wb2 (3)

wherein [η]T: limiting viscosity of total crystalline propylene polymer;

[η]b1: limiting viscosity of component (b1);

Wb1: content of component (b1) (% by weight); and

Wb2: content of component (b2) (% by weight)

Isotacetic propylene polymer satisfying the above condition is preferably used for the component (b2). Among them, propylene homopolymer, crystalline copolymer of propylene with ethylene, α-olefin, etc., and a polymer of non-crystalline ethylene-α-olefin copolymer dispersed in crystalline propylene polymer are specifically preferable. Examples of specifically preferable component (b2) which can be mentioned are a propylene homopolymer, a random copolymer with propylene and 10% by weight or less of ethylene, a random copolymer with propylene and 30% by weight or less of α-olefin having carbon number 4 to 12, or a ternary random copolymer with propylene, 10% by weight or less of ethylene and 30% by weight or less of α-olefin having carbon number 4 to 12. When amount of monomer other than propylene exceeds such range, almost crystallinity is lost and a product value may be lost.

The limiting viscosity of the total propylene polymer of the present invention is less than 3 dl/g. When it is 3 dl/g or more, the fluidity in the total system become worse, and it may cause problem in the processing. Preferably limiting viscosity is 1 dl/g or more and less than 3 dl/g, more preferably 1 dl/g or more and below 2 dl/g.

Mw/Mn of the total propylene polymer of the present invention is less than 10. When Mw/Mn is 10 or more, the molded product may be damaged and the elongation characteristic may be lost. Preferable Mw/Mn is 4 or more and less than 8.

The propylene polymer (b1) of the present invention can be obtained by using stereospecific olefin polymerization catalyst. Preferably, for example, it is the catalytic system with essential component of Ti, Mg and halogen. More preferably, the component (b1) can be obtained by employing the catalyst and the condition of the production, which can provide the polymerization activity in polymerization rate of 2000 g or more/hour·g of catalyst, in the polymerization of monomer. “The catalyst 1 g” herein indicates 1 g of solid catalyst comprising Ti, Mg and halogen as essential components.

With regard to the catalyst, for example, the catalyst described in JP-A-07-216017 can preferably be used. Specifically, examples of the catalysis system which can be mentioned are: (a) a solid catalyst containing trivalent titanium compound which can be obtained by the process such that after the solid product obtained by reducing a titanium compound represented by the general formula, Ti(OR3)ₐX₄₋ₐ, wherein R3 is hydrocarbon group having carbon number 1 to 20, X is halogen atom, and a is a numeral of 0<a≦4, preferably 2≦a≦4, in particular preferably a=4, by an organic magnesium compound, in which preferably used are in particular Grignard reagent, dialkylmagnesium compound and diarylmagnesium compound, in the presence of organosilicon compound having Si—O bond, in which preferable compound is alkoxysilane compound represented by the general formula, Si(OR1)ₘ(R2)₄₋ₘ, wherein R1 and R2 are hydrocarbon group having carbon number 1 to 20, and m is preferably 1≦m≦4, in particular tetraalkoxysilane compound with m=4, and ester compound, in which monovalent and polyvalent carboxylate ester is used, and olefinic carboxylate ester such as methacrylate ester, maleate ester, etc. and phthalate ester are preferable, and in particular phthalate diester is preferred, and the thus treated solid product is treated with a mixture of ether compound, in which dialkyl ether is used, in particular dibutyl ether and diisoamyl ether are preferably used, and titanium tetrachloride or a mixture of ether compound, titanium tetrachloride and ester compound to obtain the solid catalyst containing trivalent titanium compound; (b) organic aluminum compound, in which triethyl aluminum, triisobutyl aluminum, a mixture of triethyl aluminum and diethyl aluminum, and tetraethyldialmoxane etc. are preferably used; and (c) electron donor compound, in which tert-butyl-n-propyldimethoxysilane, tert-butylethyldimethoxysilane, dicyclopentyldimethoxysilane, etc. are preferably used.

Condition of process for production of propylene polymers (b1) and (b2) of the present invention which can be used is, for example, such that a molar ratio of (b) Al atom in organic aluminum compound/(a) Ti atom in solid catalyst is generally set to 1 to 2,000, preferably 5 to 1,500, and a molar ratio of (c) electron donor compound/(b) Al atom in organic aluminum compound is generally set to 0.02 to 500, preferably 0.05 to 50.

A process for production of the polymer of component (b1) which can be used includes a solvent polymerization using inert solvent typified by hydrocarbon such as hexane, heptane, octane, decane, cyclohexane, methylcyclohexane, benzene, toluene, xylene, etc., bulk polymerization using liquid monomer as the solvent, and vapor phase polymerization performing in vapor monomer. Among them, the bulk polymerization and the vapor phase polymerization are preferable due to easier after-treatment.

Polymerization temperature of the component (b1) is generally ranging from 20 to 150° C., preferably 35 to 95° C. The polymerization in this temperature range is preferred from the standpoint of the productivity, and is preferable for obtaining desired amount of ratio of the component (b1) and the component (b2).

Use of the catalytic system and the condition of the production providing the polymerization rate of 2000 g or more/hour·g of the catalyst in the polymerization of the component (b1) is preferable, since it gives high production efficiency and removal of the catalyst is unnecessary due to no decrease in heat resistance and coloration caused by residue of the catalyst in the polymer.

Production of the component (b2) can be performed by such that after the component (b1) is produced, the polymerization is continued within the same polymerization tank, or after the component (b1) is produced, the polymerization is performed in the different polymerization tank. In the latter polymerization process, the solvent polymerization, the bulk polymerization, the vapor phase polymerization or combination thereof can be used. Specifically, the bulk polymerization, the vapor phase polymerization or combination thereof is preferable since it provides high polymerization activity and easier after treatment.

The polymerization rate in the production of the component (b2) is preferably adjusted to be 2 times or more/hr·g of catalyst the polymerization rate in the production of the component (b1). More preferably, it is 3 times or more. The polymerization temperature herein can be the same or different, and is generally ranging from 20 to 150° C., preferably 35 to 95° C. When the polymerization rate of the component (b2) is below 2 times/hr·g of catalyst the polymerization rate of the component (b1), not only the production efficiency is down but also the quantitative ratio of the component (b1) and the component (b2) required in the polymer can not be achieved.

The polypropylene resin (B) of the present invention is provided as the product, if necessary, after performing catalyst inactivation, removal of solvent, removal of monomer, drying, and granulation as the after treatment.

The polypropylene resin (B) of the present invention may contain, within the range without deteriorating an object of the present invention, if necessary, various additives, for example, primary and secondary antioxidant, ultraviolet absorber, antistatic agent, nucleating agent, pigment, filler, etc.

The polyethylene resin (C) used in the present invention is the ethylene homopolymer or the ethylene-α-olefin copolymer resin containing a monomer unit based on ethylene and a monomer unit based on α-olefin of carbon number 3 to 20, and the polymer has the melting peak temperature in the range between 90 and 170° C. (inclusive) on a curve of differential scanning calorimetry measured according to JIS K-7121 (1987). Examples of α-olefin which can be mentioned are propylene, 1-butene, 1-pentene, 1-hexene, 1-heptene, 1-octene, 1-nonene, 1-decene, 1-dodecene, 4-methyl-1-pentene, 4-methyl-1-hexene, etc. These can be used alone or in combination with 2 or more. Preferred α-olefin is 1-hexene and 4-methyl-1-pentene. Further, preferred polyethylene resin is the resin having heat quantity of melting at the melting peak between 50 and 130 J/g (inclusive).

When ethylene-α-olefin copolymer resin is used, content of monomer unit based on ethylene is generally 50 to 99.5% by weight to the total weight of ethylene-α-olefin copolymer (100% by weight). Further, content of monomer unit based on α-olefin is generally 0.5 to 50% by weight to the total weight of ethylene-α-olefin copolymer (100% by weight).

When ethylene-α-olefin copolymer resin is used, a copolymer is preferably the copolymer of ethylene and α-olefin having carbon number 4 to 10, preferably the copolymer of ethylene and α-olefin having carbon number 5 to 10, more preferably the copolymer of ethylene and α-olefin having carbon number 6 to 10. For example, ethylene-1-hexene copolymer, ethylene-4-methyl-1-pentene copolymer, ethylene-1-octene copolymer, ethylene-1-butene-1-hexene copolymer, ethylene-1-butene-4-methyl-1-pentene copolymer, ethylene-1-butene-1-octene copolymer, etc. can be mentioned, and ethylene-1-hexene copolymer, ethylene-4-methyl-1-pentene copolymer, ethylene-1-butene-1-hexene copolymer and ethylene-1-butene-4-methyl-1-pentene copolymer are preferable, more preferred examples are ethylene-1-hexene copolymer and ethylene-1-butene-1-hexene copolymer.

MFR of the polyethylene resin (C) is generally 0.01 to 100 g/10 min. The melt flow rate is preferably 0.05 g/10 min. or more, more preferably 0.1 g/10 min. or more from the standpoint of more reducing the extrusion load in the extrusion molding. Further, from the standpoint of more strengthen the mechanical strength of the extrusion molding product, it is preferably 20 g/10 min. or less, more preferably 10 g/10 min. or less, further more preferably 6 g/10 min. or less. The melt flow rate is a value measured under the condition at 190° C. with the loading 21.18 N according to the method defined in method A, JIS K7210-1995. In the measurement of the melt flow rate, generally, polyethylene resin, to which antioxidant is previously blended approximately 1000 ppm, is used.

The melt flow rate ratio (MFRR) of the polyethylene resin (C) of the present invention is preferably 40 or more, more preferably 50 or more from the standpoint of improved processability. The melt flow rate ratio (MFRR) is a value, in which a melt flow rate measured at 190° C. with the loading 211.82 N (21.60 kg) is divided by a melt flow rate measured with the loading 21.18 N (2.16 kg), according to the method defined in JIS K7210 (1995). Further, in the measurement of the melt flow rate, generally, the polymer, to which antioxidant is previously blended approximately 1000 ppm, is used.

Density of the polyethylene resin (C) is generally 890 to 970 kg/m³, and from the standpoint of improved rigidity of the obtained molded product, preferably 906 kg/m³ or more, more preferably 908 kg/m³ or more, and in addition, from the standpoint of improved impact resistance of the obtained molded product, preferably 940 kg/m³ or less, more preferably 930 kg/m³ or less. The density is measured according to the method defined in method A in JIS K7112-1980 after annealing described in JIS K6760-1995.

A molecular weight distribution (Mw/Mn) of the polyethylene resin (C) of the present invention is preferably 3 or more, more preferably 4 or more and even more preferably 6 or more from the standpoint of improved processability. Further, from the standpoint of improving texture of the extrusion molding product, it is preferably 25 or less, more preferably 20 or less, further more preferably 15 or less. The molecular weight distribution (Mw/Mn) is a value (Mw/Mn) dividing Mw by Mn after obtaining weight-average molecular weight (Mw) and number average molecular weight (Mn) converted to polystyrene by the gel-permeation chromatography.

In the present invention, the polyethylene resin (C) is preferably ethylene homopolymer resin (C1) or ethylene-α-olefin copolymer resin (C2) which has long chain branching and is excellent in moldability.

Example of the ethylene homopolymer resin (C1) used in the present invention which can be mentioned is, for example, low-density polyethylene resin produced according to the description hereinbelow. Known low-density polyethylene resin is Sumikasen distributed commercially from Sumitomo Chemical Co., Ltd., etc.

Production of low-density polyethylene resin is generally performed by polymerizing ethylene in a tank-type polymerization reactor or a tube-type polymerization reactor under condition of polymerization pressure at 1400 to 3000 kg/cm², polymerization temperature at 200 to 300° C., in the presence of radical initiator. In the production, chain transfer agent such as hydrogen, etc. may be added, and inert component for polymerization such as nitrogen or pentane may also be added.

Ethylene homopolymer resin (C1) or ethylene-α-olefin copolymer resin (C2) of the present invention are preferably to have high fluidity activation energy (Ea).

Ea of the ethylene homopolymer resin (C1) or the ethylene-α-olefin copolymer resin (C2) is preferably 40 kJ/mol or more, more preferably 50 kJ/mol or more, still more preferably 60 kJ/mol from the standpoint of increasing drawdown property. Further, from the standpoint of decreasing extrusion load, Ea is preferably 100 kJ/mol or less, more preferably 90 kJ/mol or less.

Fluidity activation energy (Ea) is a numeral value calculated by Arrhenius equation from shift factor (a_{T}) when master curve showing angular frequency (unit: rad/sec) dependency of melting complex viscosity (unit: Pa·sec) at 190° C. based on the principle of temperature-time superposition, and is a value obtained by the following method. Specifically, the melting complex viscosity-angular frequency curve (wherein unit of melting complex viscosity is Pa·sec and unit of angular frequency is rad/sec) of ethylene-α-olefin copolymer in each temperature (T, unit: ° C.) at 130° C., 150° C., 170° C. and 190° C. is superposed on the melting complex viscosity-angular frequency curve of ethylene copolymer at 190° C. in each melting complex viscosity-angular frequency curve at each temperature (T) based on the temperature-time superposition principle to obtain a shift factor (a_{T}) at each temperature (T), and the first-order approximation formula (formula (4) hereinbelow) of [ln(a_{T})] and [1/(T+273.16)] is calculated by the least square from each temperature (T) and the shift factor (a_{T}) at each temperature (T). Subsequently, Ea is obtained from a gradient m of the first-order approximation formula and the formula (5) hereinbelow.

ln(a_{T})=m(1/(T+273.16))+n (4)

Ea=|0.008314×m| (5)

a_{T}: shift factor

Ea: activation energy of fluidity (unit: kJ/mol)

T: temperature (unit: ° C.)

The above calculation may be performed by using commercially available calculation software, and example of the calculation software includes Rhios V.4.4.4 (Rheometrics Inc.).

The shift factor (a_{T}) is a distance wherein both logarithmic curves of the melting complex viscosity−angular frequency curve at each temperature (T) are displaced to the direction of log(Y)=−log(X) axis, with the proviso that Y axis is the melting complex viscosity and X axis is the angular frequency curve, and superposed on the melting complex viscosity-angular frequency curve at 190° C., and in the superposition, both logarithmic curves of the melting complex viscosity-angular frequency curve at each temperature (T) are displaced a_{T} times in the angular frequency curve and 1/a_{T} times in the melting complex viscosity depending on each curve. A correlation coefficient for obtaining the formula (I) by the least square from the value of 4 points at 130° C., 150° C., 170° C. and 190° C. is generally 0.99 or more.

Measurement of melting complex viscosity-angular frequency curve is performed by using viscoelasticity measuring instrument (for example, Rheometrics Mechanical Spectrometer, RMS-800, Rheometrics Inc.) under the condition generally in geometry: parallel plate, diameter of plate: 25 mm, plate distance: 1.5 to 2 mm, strain: 5%, angular frequency: 0.1 to 100 rad/sec. Measurement is performed under nitrogen atmosphere, and proper quantity of antioxidant (e.g. 1000 ppm) is preferably blended previously in the test sample.

Ea of previously known conventional ethylene-α-olefin copolymer is lower than 40 kJ/mol, and sufficient satisfied drawdown property could not be obtained in sometimes. Consequently, according to the manufacturing process hereinbelow, ethylene-α-olefin copolymer resin with high Ea can be obtained.

A process for production of ethylene-α-olefin copolymer (C2) of the present invention includes a process for copolymerizing ethylene and α-olefin by using metallocene polymerization catalyst obtained by contacting cocatalyst (D) hereinbelow, metallocene complex (E) having ligand bonding with the ligand compound having two cyclopentadienyl skeletons through one substituent and organic aluminum compound (F).

Examples of the metallocene complex (E) having ligand bonding with the ligand substituent having two cyclopentadienyl skeletons through one substituent are such that: among the metal atoms in group IV in periodic table, zirconium and hafnium are preferable; examples of ligand substituent having cyclopentadienyl skeleton are preferably indenyl group, methylindenyl group, methylcyclopentadienyl group, dimethylcyclopentadienyl group; examples of substituent bonded with ligand substituent are preferably ethylene group, dimethylmethylene group, dimethylsilylene group. Preferred metallocene complex are ethylene bis(1-indenyl)zirconium dichloride and ethylene bis(1-indenyl)zirconium diphenoxide, ethylene bis(1-indenyl)zirconium dichloride and dimethylsilylene bis(1-indenyl)zirconium dichloride. Among them, ethylene bis(1-indenyl)zirconium diphenoxide is preferred.

Examples of the cocatalyst carrier (D) are a carrier obtained by contacting with (d1) diethyl zinc, (d2) two types of fluorinated phenol, (d3) water, (d4) inorganic compound particles and (d5) trimethyldisilazane (((CH₃)₃Si)₂NH), and a carrier obtained by contacting with (d6) alkylalumioxane and (d4) inorganic compound particles.

Examples of (d2) fluorinated phenol are preferably pentafluorophenol, 3,4,5-trifluorophenol, and 2,4,6-trifluorophenol. Further, an example of (d4) inorganic compound particles is preferably silica gel.

Amount of use in the above each component of (d1) diethyl zinc, (d2) two types of fluorinated phenol and (d3) water is not limited, and when molar ratio of amount of use of each component is set as (d1) diethyl zinc, (d2) two types of fluorinated phenol, (d3) water=1: x:y, preferably X and y is satisfied the following equation.

|2−x−2y|≦1 (6)

The above x in the equation is preferably numerals from 0.01 to 1.99 (inclusive), more preferably numerals from 0.10 to 1.80 (inclusive), further preferably numerals from 0.20 to 1.50 (inclusive), most preferably numerals from 0.30 to 1.00 (inclusive).

Amount of (d4) inorganic compound particles used for (d1) diethyl zinc is such that zinc atom derived from (d1) diethyl zinc contained in particles obtained by contacting with (d1) diethyl zinc and (d4) inorganic compound particles is preferably an amount of 0.1 mmol or more as in mole number of zinc atom contained in the obtained particle 1 g, more preferably an amount to be 0.5 to 20 mmol. Amount of (d5) trimethyldisilazane used for (d4) inorganic compound particles is preferably (d5) trimethyldisilazane 0.1 mmol or more per (d4) inorganic compound particles 1 g, more preferably amount to be 0.5 to 20 mmol.

Examples of organic aluminum compound (F) are preferably triisobutyl aluminum and tri-n-octyl aluminum.

Amount of use of metallocene complex (E) is preferably 5×10⁻⁶-5×10⁻⁴ mol to cocatalyst (D) 1 g. Further, amount of organic aluminum compound (F) is 1 to 2000 expressed as ratio of mole number of aluminum atom of organic aluminum compound (F) to mole number of zirconium atom of crosslinked bis-indenyl zirconium complex (E) (Al/Zr).

With regard to cocatalyst (D), when a carrier obtained by contacting with (d1) diethyl zinc, (d2) two types of fluorinated phenol, (d3) water, (d4) inorganic compound particles and (d5) trimethyldisilazane (((CH₃)₃Si)₂NH) is used, ethylene and α-olefin is preferably copolymerized by using metallocene catalyst obtained by contacting with electron donor compound (G) in addition to metallocene complex (E) and organic aluminum compound (F). Examples of the electron donor compound (G) are preferably triethylamine, tri-n-octylamine. Amount of use of the electron donor compound (G) is 0.1 to 10 mol % to the mole number of aluminum atom in organic aluminum compound (F), preferably ranging from 1 to 5 mol %.

Polymerization method is preferably continuous polymerization accompanied by formation of ethylene-α-olefin copolymer particles, for example continuous vapor phase polymerization, continuous slurry polymerization and continuous bulk polymerization, and continuous vapor phase polymerization is preferred. The vapor phase polymerization reactor is generally a rector with fluidized-bed reaction tank, preferably the reactor with fluidized-bed reaction tank attached with extension appliance. Stirrer may be equipped in the reaction tank.

A method for supplying each component of metallocene polymerization catalyst used for production of ethylene-α-olefin copolymer resin of the present invention to the reaction tank which can be used includes a method supplying in the condition without water by using nitrogen, inert gas such as argon, hydrogen, ethylene, etc., a method supplying in the condition of solution or slurry by dissolving or diluting each component into the solvent, and others. Each component of catalyst may be supplied individually or may be supplied by contacting previously with any component in any order.

Prior to performing the polymerization, preliminary polymerization is performed and a component of the preliminary polymerized preliminary polymerization catalyst is preferably used as the catalyst component or the catalyst of the main polymerization.

Polymerization temperature is generally below the temperature melting the ethylene-α-olefin copolymer resin, and is preferably 0 to 150° C., more preferably 30 to 100° C. From the standpoint of improving activated energy of fluidity (Ea) of ethylene-α-olefin copolymer of the present invention, higher temperature than 75° C., specifically ranging from 75° C. to 90° C. is preferable. Further, hydrogen may be added as the molecular weight modulator in order to modulate melting fluidity of the ethylene-α-olefin copolymer. In addition, inert gas may coexist in mixed gas.

Polymerization time is generally ranging from 0.5 to 20 hours, preferable 1 to 10 hours.

Equipment for melting and mixing component (A), (B) and (C) may includes any methods appropriate for obtaining homogeneous mixture such as kneading using uniaxial extruder or biaxial extruder. Further, if necessary, additives such as fire retardant, antistatic agent, heat-resistant stabilizer, anti-degradation agent, mold lubricant, etc. may be blended.

Laminate of the present invention is the laminate having layers consisting of the layer containing the components (A), (B) and (C) and the layer consisting of urethane foam or olefin foam.

The olefin foam is the form consisting of common polyolefin resin such as polyethylene resin, polypropylene resin, mixed resin of polyethylene resin and polypropylene resin, vinyl acetate resin, etc. The olefin foam may be any of crosslinked olefin foam or non-crosslinked olefin form. Proviso that when the crosslinked olefin foam is used, a sheet for molding with excellent molding processability can be obtained as compared with the case using non-crosslinked olefin foam.

A magnification ratio of the olefin form is preferably 2 to 40 magnification, specifically 5 to 20 magnification. Further, preferable thickness is 2 to 15 mm, specifically 4 to 10 mm. When the magnification ratio and the thickness are outside the range, a molded product with good shape maintenance is difficult to obtain, further effect of feeling of the foam layer and shock-absorbing properties can not be sufficiently obtained. When the olefin foam consists of crosslinked polyolefin foam, gel fraction is preferably 15 to 70, specifically 30 to 50. When the gel fraction is below 15%, pressure tightness of the foam layer may be reduced. Contrary to that, when it exceeds 70%, degree of elongation of the foam may be reduced and the moldability is decreased. The gel fraction is a value shown by % by weight of insoluble material remained after immersing the form specimen 0.1 g in tetralin at 130° C. for 3 hours.

Blending quantity of the component (A), (B) and (C) is, when the component (A), (B) and (C) in total is set as 100% by weight, such that a content of the component (A) is 5 to 94% by weight; a content of the component (B) is 1 to 90% by weight; and a content of the component (C) is 5 to 70% by weight; and preferably the content of the component (A) is 10 to 85% by weight; the content of the component (B) is 5 to 80% by weight; and the content of the component (C) is 10 to 55% by weight. If content of the component (A) is insufficient, flexibility of the product may be deteriorated. If content of the component (A) is in excess, when the product is subjected to secondary processing such as vacuum forming, sufficient elongation can not be obtained and breaking the molded product may occur. If content of the component (B) is insufficient, fluidity is decreased and molding processability such as sheet processing may be worsen. If content of (B) is in excess, flexibility of the product may be damaged. If content of the component (C) is insufficient, calender rolling processability may be decreased and the drawdown property may deteriorate when the product is subjected to secondary processing such as vacuum forming. If content of the component (C) is in excess, flexibility of the product may be deteriorated.

### EXAMPLES

The present invention will be explained hereinbelow by examples, however the present invention is not limited within these examples.

### [1] Evaluation Method

### (1) Ratio of Amount of Ethylene Monomer Unit and Amount of Propylene Monomer Unit in Ethylene-Propylene Copolymer Rubber

Measurement was performed by infrared spectroscopy.

### (2) Mooney Viscosity (MLₗ₊₄ 100° C.)

Measurement was performed at 100° C. according to ASTM D-927-57T.

### (3) Melt Flow Rate (MFR)

According to JIS K7210 (1999), propylene resin was measured at 230° C., and polyethylene resin and ethylene-α-olefin copolymer resin were measured at 190° C. under condition of loading 21.18 N by method A, respectively.

### (4) Melt Tension (MT)

Using the melt tension tester Type MT-501D3, Toyo Seiki Co., Ltd., a strand was extruded using the sample 5 g from the orifice with a length 8 mm and a diameter 2 mm, at residual temperature of 190° C., for residual heat time of 5 minutes, and at extrusion rate 5.7 mm/min., and the strand was rolled up at rolling rate of 6 m/min. using a roller with a diameter 50 mm. The tensile force obtained by that was measured as the melt tension (MT) (unit=cN).

### (5) Melt Flow Rate Ratio (MFRR)

According to the method defined in JIS K7210 (1995), a value of the melt flow rate measured by the method A under the condition of loading 211.8N, temperature at 190° C. was divided by a value measured by the method A under the condition of loading 21.18N, temperature at 190° C., and the divided value was set as MFRR.

### (6) Density

Density was measured by the method defined in the method A in JIS K7112-1980. Sample was subjected to annealing described in JIS K6760-1995.

### (7) Activation Energy of Fluid (Ea)

Using viscoelasticity measuring instrument (Rheometrics Mechanical Spectrometer, RMS-800, Rheometrics Inc.), the melting complex viscosity-angular frequency curve was measured under the measurement condition hereinbelow at 130° C., 150° C., 170° C. and 190° C., subsequently master curve of the melting complex viscosity-angular frequency curve was prepared at 190° C. by using the calculation software Rhios V.4.4.4 made in Rheometrics Inc. to obtain the activation energy (Ea).

### (Measurement Condition)

geometry: parallel plate,

diameter of plate: 25 mm,

plate distance: 1.5 to 2 mm,

strain: 5%,

angular frequency: 0.1 to 100 rad/sec.

measurement atmosphere: nitrogen

### (8) Molecular Weight Distribution (Mw/Mn)

Using gel-permeation chromatography (GPC), weight-average molecular weight (Mw) and number average molecular weight (Mn) were measured by the following conditions (1) to (7) to obtain the molecular weight distribution (Mw/Mn).

(1) Equipment: Waters 150 C (Water Inc.)

(2) Separation column: TOSOH TSKgelGMH6-HT

(3) Measurement temperature: 140° C.

(4) Carrier: o-dichlorobenzene

(5) Flow volume: 1.0 ml/min.

(6) Injection volume: 500 μl

(7) Detector: differential refractometry

(8) Molecular weight standard substance: standard polystyrene

(9) Calender molding processability

Using two rolls (8 inch roll, Kansai Roll Co., Ltd.), pellet 150 g was rolled up at roll surface temperature of 170° C., guide width 30 cm and roll gap 1 mm, and subjected to crosscut kneading for 1 minute. Thereafter, roll gap was set to 0.3 mm, the rolled material was allowed to leave for 3 minutes, and peeled off from the roll. Adhesiveness to the heated roll at that time was determined according to the criteria hereinbelow.

◯: Throughout a period of time for 4 minutes, low adhesiveness to the roll surface was observed to reveal superior processability. Rapidly peeled off when the material was peeled off from the roll.

Δ: Adhesiveness on the roll surface was strong and peeling off the sheet was difficult.

x: Adhesiveness on the roll surface was very strong and peeling off the sheet was impossible.

### (10) Drawdown Property

Vacuum molding machine (Nakakura Planning Co. Ltd., Type TF-16-VP) was used for measurement. At first, a sheet of thermoplastic elastomer composition prepared separately was fixed by the clamp. Subsequently, surface temperature of the sheet was heated to 160° C., 180° C. and 200° C., and appearance of drawdown of the sheet at each heating temperature was recorded by using digital camera (Olympus CAMEDIA C-3030 ZOOM). Thereafter, using such images, distance from the base level of clamping surface to the most drawdown position to the vertical direction was measured, and drawdown length was measured.

Thereafter, sheet surface temperature (° C.) was plotted on the abscissa axis and drawdown length (mm) was plotted on the axis of ordinate, and the gradient of the approximate curve was calculated. Smaller gradient (temperature dependency of the drawdown length) indicates smaller variation of the drawdown to the temperature changes, exhibiting good vacuum forming properties over broad temperature range.

### (11) Tensile Property

Using JIS No. 3 dumbbell punched from a sheet of thermoplastic elastomer composition prepared separately, tensile property was measured by the tensile rate 200 mm/min. according to a method defined in JIS K6251 (1993). Strength at break (MPa) and elongation at break (%) were calculated from the result of measurement.

### [2] Raw Materials

Various raw materials are listed hereinbelow. In Table 1, various properties are described.

### (1) Ethylene-α-Olefin Copolymer Rubber

EP-1: Sumitomo Chemical Co. Ltd., Esplene E222 (ethylene-propylene copolymer rubber)

### (2) Polypropylene Resin

PP-1: Basel Co. Ltd., PF814

[η]=1.8 dl/g

PP-2: Sumitomo Chemical Co. Ltd., Noblene EL80F1

[η] b1=7.9 dl/g, [η]b2=1.2 dl/g, content of b1 component 10% by weight, content of b2 component 90% by weight, b1 component and b2 component are propylene homopolymer.

PP-3: Sumitomo Chemical Co. Ltd., Noblene Y501N

[η]=1.5 dl/g,

### (3) Polyethylene Resin

PE-1: Sumitomo Chemical Co. Ltd., Sumikasen G202

### (4) Ethylene-α-Olefin Copolymer Resin

PE-2: Sumikasen GMH CB5001

PE-3: Sumitomo Chemical Co. Ltd., Sumikasen E FV205

### Examples 1 to 4 and Comparative Examples 1 to 4

Ethylene-α-olefin copolymer rubber, polypropylene resin, polyethylene resin and ethylene-α-olefin copolymer resin having blending quantity shown in Tables 2 and 3 were melting kneaded by using Banbury mixer to prepare pellets.

The olefin thermoplastic elastomer composition was subjected to sheet molding by using 40 mmφ T-diesheet processing machine (mirror surface roll was used) at resin temperature of 200° C.±20° C. to obtain the thermoplastic elastomer composition sheet with sheet thickness 1 mm and width 40 cm. Subsequently, evaluation of drawdown property and tensile property of the sheet was performed. Results of evaluation are shown in both Tables 2 and 3.

TABLE 1

| | | EP-1 | PP-1 | PP-2 | PP-3 | PE-1 | PE-2 | PE-3 |
|---|---|---|---|---|---|---|---|---|
| Ethylene | wt % | 52 | — | — | — | — | — | — |
| monomer | | | | | | | | |
| unit | | | | | | | | |
| ML₁₊₄ | — | 68 | — | — | — | — | — | — |
| 100° C. | | | | | | | | |
| MFR | g/10 min. | — | 3.0 | 13 | 13 | 1.5 | 0.5 | 2.0 |
| MT | cN | — | 46 | 5.1 | 0.58 | — | — | — |
| MFRR | — | — | — | — | — | 45 | 64 | 17 |
| Density | kg/m³ | — | — | — | — | 919 | 920 | 921 |
| Ea | kJ/mol | — | — | — | — | 70 | 74 | 31 |
| Mw/Mn | — | — | 5.0 | 8.0 | 4.0 | 13 | 9.9 | 2.9 |

TABLE 2

| | | Example 1 | Example 2 | Example 3 | Example 4 |
|---|---|---|---|---|---|
| EP-1 | Parts by weight | 60 | 60 | 60 | 60 |
| PP-1 | Parts by weight | 30 | | 30 | |
| PP-2 | Parts by weight | | 30 | | 30 |
| PE-1 | Parts by weight | 10 | 10 | | |
| PE-2 | Parts by weight | | | 10 | 10 |

Various molding processability

| | | | | | |
|---|---|---|---|---|---|
| Calendar molding | — | ◯ | ◯ | ◯ | ◯ |
| processability | | | | | |
| Temperature dependency | mm/° C. | 0.07 | 0.40 | 0.24 | 0.30 |
| of drawdown | | | | | |

Tensile property

| | | | | | |
|---|---|---|---|---|---|
| Strength at break | MPa | 5.2 | 6.4 | 5.2 | 6.8 |
| Elongation at break | % | 517 | 620 | 533 | 649 |

TABLE 3

| | | Comparative | Comparative | Comparative | Comparative |
|---|---|---|---|---|---|
| | | Example 1 | Example 2 | Example 3 | Example 4 |
| EP-1 | Parts by weight | 60 | 60 | 60 | 70 |
| PP-1 | Parts by weight | | | | 30 |
| PP-3 | Parts by weight | 30 | 30 | 30 | |
| PE-1 | Parts by weight | 10 | | | |
| PE-2 | Parts by weight | | 10 | | |
| PE-3 | Parts by weight | | | 10 | |

Various molding processability

| | | | | | |
|---|---|---|---|---|---|
| Calender molding | — | Δ | ◯ | ◯ | Δ |
| processability | | | | | |
| Temperature dependency | mm/° C. | 0.46 | 0.58 | 0.56 | 0.18 |
| of drawdown | | | | | |

Tensile property

| | | | | | |
|---|---|---|---|---|---|
| Strength at break | MPa | 5.8 | 5.9 | 5.8 | 3.4 |
| Elongation at break | % | 462 | 572 | 554 | 389 |

### ADVANTAGE OF THE INVENTION

According to the present invention, thermoplastic elastomer composition with small adhesiveness to calender roll and having stable drawdown property in broad temperature range in vacuum forming can be obtained.

1. A thermoplastic elastomer composition comprising the following component (A) in an amount of 5 to 94% by weight, the following component (B) in an amount of 1 to 90% by weight and the following component (C) in an amount of 5 to 70% by weight, with the proviso that an amount in total of the components (A), (B) and (C) is set to 100% by weight:
(A) an ethylene-α-olefin copolymer rubber;
(B) a polypropylene resin which satisfies the following equation (1) in a melt tension (MT) at 190° C. and a melt flow rate (MFR) at 230° C.
log MT>−0.9 log MFR+0.8 (1);
and
(C) a polyethylene resin comprising: an ethylene monomer alone; or a monomer unit derived from ethylene and a monomer unit derived from α-olefin with 3 to 20 carbon atoms and having a density of 890 to 970 kg/m³.

2. The thermoplastic elastomer composition according to claim 1, wherein the component (B) is a polypropylene resin (B1) comprising a propylene-based polymer containing a crystalline propylene-based polymer component (b1) and a crystalline propylene-based polymer component (b2) wherein, in the first step, the component (b1) having a limiting viscosity of 5 dl/g or more is produced by polymerizing a monomer comprising propylene as a main component and, continuously afterward in the second step, the component (b2) having a limiting viscosity of below 3 dl/g is continuously produced by polymerizing a monomer comprising propylene as a main component, and a content of the component (b1) in the propylene-based polymer is 0.05% by weight or more and below 25% by weight, and a limiting viscosity of the total propylene-based polymer is below 3 dl/g and a molecular weight distribution Mw/Mn is below 10.

3. The thermoplastic elastomer composition according to claim 1, wherein the component (C) has a monomer unit derived from ethylene and a monomer unit derived from α-olefin with 3 to 20 carbon atoms, and the component (C) is an ethylene homopolymer resin (C1) or an ethylene-α-olefin copolymer resin (C2) having a fluid activation energy (Ea) of 40 kJ/mol or more.

4. The thermoplastic elastomer composition according to claim 1 wherein the component (B) is the polypropylene resin (B1) according to claim 2 and the component (C) is the ethylene homopolymer resin (C1) or the ethylene-α-olefin copolymer resin (C2) according to claim 3.

5. A laminate comprising: a layer comprising an urethane-based foam or an olefin-based foam; and the thermoplastic elastomer composition according to any one of claims 1 to 4.

6. A molding method comprising the step of: vacuum forming the thermoplastic elastomer composition according to any one of claims 1 to 4 at a temperature of a melting point or above of the component (B) or the component (B1) to obtain a molded product.

7. A molding method comprising the step of:
vacuum forming the laminate according to claim 5 at a temperature of a melting point or above of the component (B) or the component (B1) to obtain a molded product.

8. A molded member obtained by the method of claim 6 used for an automobile interior material.

9. A molded member obtained by the method of claim 7 used for an automobile interior material.
